(19) United States
(12) Patent Application Publication
(10) Pub. No.: US 2010/0028490 A1
(43) Pub. Date: Feb. 4, 2010

(54) BREAD IMPROVER AND USE THEREOF IN MAKING CRUMB-FREE FLAT BREAD

(75) Inventor: Jean-Jacques Muchembled, Marcq En Baroeul (FR)

Correspondence Address: YOUNG & THOMPSON, 209 Madison Street, Suite 500, Alexandria, VA, 22314, US

(73) Assignee: LESAFFRE ET COMPAGNIE, PARIS (FR)

(21) Appl. No.: 12/441,642

(22) PCT Filed: Sep. 14, 2007
(86) PCT No.: PCT/FR07/51945

§ 371 Date: May 1, 2009

(30) Foreign Application Priority Data
Sep. 20, 2006 (FR) 06 08254

(51) Int. Cl. A21D 8/04; A21D 2/38

(52) U.S. Cl. 426/20; 426/64

(57) ABSTRACT

A new bread-making enhancer includes an anti-stale enzyme, an enzyme of the arabinofuranosidase type and a drying component selected from fibres, gums and hydrocolloids. The enhancer is suited for methods for making bread without a soft part such as flat bread or Arab bread.

The present invention relates to the field of bread-making, in particular to the field of bread improvers. It in particular relates to a bread improver and to the use thereof in making crumb-free bread.

According to the invention, the term “crumb-free bread” is intended to mean the bread consisting of two layers comprising no crumb, generally referred to as “Arab bread”, or alternatively the bread formed by a single or by two layers and comprising a crumb with a thickness of less than 1 cm. In the subsequent description, the terms “crumb-free bread”, “flat bread” and “Arab bread” denote the same product.

In certain countries, in particular Arab countries, the common bread is made up of crumb-free flat breads of various shapes or sizes. This common bread, produced in large amounts most commonly by industrial lines, is packaged in sachets. It is a commonly consumed product which serves as a staple food for the populations of these countries. It is subsidized by the government and must not exceed a certain price.

The flat bread is generally packaged in plastic sachets at a rate of several breads per sachet according to their diameter. The flat bread is sold by weight.

Despite the protection by the sachet, these breads dry rapidly. They have a short shelf life. It rarely exceeds 12 hours. They very quickly become like cardboard when chewed, the bread rapidly dries out and breaks if it is subject to folding.

Many manufacturers require better conservation of the softness over time and an extension of the product's shelf life. Furthermore, in some countries, such as in Saudi Arabia, the clients may be considerable distances from the site of production. In these countries, the climatic conditions do not favor keeping bread and the freshness of said bread. The flat bread is therefore consumed on the same day, with a maximum storage time of 12 hours.

One of the major problems to be solved is that of limiting the staling of the bread which is by nature very rapid given the absence of crumb.

At the current time, no improver exists for realizing this functionality requested by the Arab baking industry.

The production of flat bread is based on a simple baker's recipe. After kneading, the dough is rolled several times and, after a short fermentation, it is baked in a very hot oven.

The intense heat of the oven allows spectacular detachment of the bread into two sheets.

The bread is then sweated rapidly for only 5 to 10 minutes, depending on its weight and its size. The breads are then packaged in plastic sachets which are themselves placed in plastic baskets.

The only improvers that exist with regard to this type of application are generally based on cysteine diluted so as to give the dough good extension during flattening. The most well-known product, which has been on the market since 1999, is Fladden Powder from the Dutch company Sonneveld, also known under the trade name Sonn-Plus Fladden Powder. It is an improver which is used at 0.1% of the weight of flour and provides, at the dose used, only cysteine at a rate of approximately 12 ppm.

Another cysteine-based improver also exists, manufactured locally in Saudi Arabia, this being Lamsa which is used at the same dose.

In order to improve the softness and the enjoyment of taste, it is known that certain manufacturers add soya flour at 2% or 3% by weight relative to the total weight of the flour. However, it is regularly noted that the effect of the soya flour on the final bread is very limited in terms of perception in the mouth.

The applicant has found, surprisingly, that the above-mentioned problems can be solved by using, as bread improver, a mixture comprising an antistaling enzyme and a drying enzyme in combination with a drying compound.

In fact, the applicant has discovered that the improver which is the subject of the present invention makes it possible both to increase the duration of conservation of the flat bread and to give it a more enjoyable taste and improve its chewiness.

The first subject of the present invention is therefore a bread improver comprising:
a. from 0.1% to 1% by weight of the total weight of the improver of at least one antistaling enzyme chosen from maltogenic exoamylases and bacterial endoamylases;
b. from 0.8% to 9% by weight of the total weight of the improver of at least one enzyme of arabinofuranosidase type; and
c. from 90% to 99.1% by weight of the total weight of the improver of at least one drying compound chosen from the group comprising gums, hydrocolloids, fibers and mixtures thereof.

Having noted that the pronounced use of antistaling enzymes generally gives the dough a tacky effect which is very prejudicial when proceeding to flattening, the applicant has found, surprisingly and unexpectedly, that this tacky effect is erased through the use of drying enzymes such as arabinofuranosidases in combination with a drying compound such as gums, hydrocolloids or fibers. This combination allows flattening to proceed correctly.

The invention even shows that the combined effect of the drying compound/drying enzymes/antistaling enzymes provides improved extensibility compared with a normal dough.

According to an advantageous embodiment, the bread improver comprises:
a) from 0.3% to 0.8% by weight of the total weight of the improver of at least one antistaling enzyme chosen from maltogenic exoamylases and bacterial endoamylases;
b) from 1.2% to 8% by weight of the total weight of the improver of at least one enzyme of arabinofuranosidase type; and
c) from 91.2% to 98.5% by weight of the total weight of the improver of at least one drying compound chosen from the group comprising gums, hydrocolloids, fibers and mixtures thereof.

The antistaling enzymes which exist on the market can be divided up into two categories:
exoamylases, and more particularly maltogenic amylases, the most well-known of which is that sold by the company Novozymes under the name Novamyl. Besides its very high cost, which certainly prices it out of the market for this type of application, this maltogenic amylase is especially known in sandwich breads. On a normal sandwich bread, a normal dose of Novamyl maltogenic amylase, i.e. 50 ppm, makes it possible to significantly reduce the firmness of the crumb in the majority of breads containing crumb;
endoamylases of bacterial origin have a very powerful effect on doughs. By virtue of their greater heat-resistance compared with fungal amylases, they have a more pronounced hydrolytic effect in the dough.

Thus, sandwich breads are very generally found, after baking, to have a tacky chew, often referred to as “gummy or chewy”, and a crumb which is more like a gummy dough than a real breadcrumb. This gummy taste is not very pleasant when tasted at the beginning of the product's shelf life.

On certain schemes for the production of sandwich bread in molds with a short baking time, the breads can even be the subject of sinking with such enzymes.

The use of these enzymes for flat breads is not known. The use of these enzymes remains limited to conventional sandwich breads and to very low doses so as to avoid the problems of “gummy” crumb.

It is an entirely different situation with Arab breads, where the baking is very intense, very hot and at the same time very rapid.

In the improver according to the invention, as antistaling enzyme, use may be made of either maltogenic exoamylase enzymes or bacterial endo-alpha-amylases. The latter are preferred because they are more economical and very suitable for flat breads.

The applicant has discovered that, despite the extremely drying baking and the virtual absence of crumb in breads of this type, bacterial endo-alpha-amylases remain the best enzymes for the flat bread.

The bacterial endo-alpha-amylases generally used in breadmaking are of the type of Ban 800 MG from Novozymes, normally metered by biochemical metering, according to the Ceralpha method commonly used in the cereal industry at 7500 Ceralpha units/gram. They are used in sandwich breads generally at from 0.1 ppm to 0.5 ppm relative to the total amount of flour, 0.3 ppm being the maximum dose where the problems of chewy crumb already start to appear. In order to successfully generate a notable softness in the mouth for crumb-free breads, it is necessary to go to a high dose. It has been shown, during trials carried out by the applicant, that Ban 800 MG gives a positive crumb effect on flat breads from 2 ppm, i.e. a dose 6 times greater than the maximum dose acceptable in sandwich breads. The freshness effect is maximized by going up to 3 ppm. From this dose of 3 ppm of Ban 800 MG, the tackiness appears in the dough when the doughs are flattened.

Other bacterial endo-alpha-amylases that can be used in the improver of the invention are given in the table below with their conventional dosage in crumb-rich breads.

| | | | | Amounts of |
|---|---|---|---|---|
| | | | Dosage | Ceralpha units |
| | | Dose for | Ceralpha | provided per |
| Trade name | Supplier | use | units/gram | kilogram of flour |
| LICUAMIL P | ENMEX | 3 ppm | 1380 | 4.1 |
| BAN 800 MG | NOVOZYMES | 0.5 ppm | 7500 | 3.75 |
| GRINDAMYL | DANISCO | 65 ppm | 60 | 3.9 |
| TSE 1010 | | | | |
| BIOBAKE ST | KERRY | 100 ppm | 37 | 3.7 |
| 2002 | BIOSCIENCES | | | |
| VERON EL | AB ENZYMES | 2.5 ppm | 1780 | 4.5 |
| 2003 026 | | | | |

It can be noted that the various endo-alpha-amylases, even though they have different concentrations in terms of Ceralpha units, provide more or less the same amounts of Ceralpha units per kilogram of flour in the kneading machine for common breadmaking processes of the crumb-rich bread type of around 3 to 4 Ceralpha units per kilogram of flour. Above this amount introduced into the kneading machine, “gummy” or “chewy” phenomena are observed.

The antistaling enzyme which is preferred according to the invention is Ban 800 MG, which makes it possible to provide a moist and slightly “chewy” aspect which is positively perceived in the mouth. Sometimes, an improvement in pliability is also seen. Negative effects of this enzyme then appear with sticky dough phenomena which are extremely unacceptable due to the industrialization of the processes, and in particular the industrialization of the flattening. The stickiness generated by the enzyme prevents correct flattening of the dough pieces, creates jamming phenomena on industrial lines, and causes many manual interventions to be carried out on the passage of the dough pieces in order to unblock the line. It should be used at an amount of between 0.1% and 1% by weight relative to the total weight of the improver, and preferably from 0.3% to 0.8%.

The improver according to the invention also uses at least one drying enzyme.

Among the drying enzymes conventionally used, the most well-known is glucose oxidase, which gives doughs with very smooth appearances and which also has a drying effect on the doughs. The drawback of this glucose oxidase is that it is also an oxidizing enzyme and that it generates a lot of elasticity upon kneading, in a manner quite similar to ascorbic acid. In the case of Arab bread, the oxidation of the dough, generally desired for supporting the fermentation due to the yeast, is a serious drawback. All oxidants or ingredients with oxidizing effects, and in particular glucose oxidase, have an ovalizing effect on Arab breads. This appearance of elasticity is disadvantageous for correctly obtaining the circumference during flattening and should be strictly avoided.

In the improver according to the invention, an enzyme of arabinofuranosidase type is used as drying enzyme.

Among the enzymes of arabinofuranosidase type, mention may be made of that recently marketed in pure form by the company DSM, under the name Bakezyme ARA 10000 BG. It is an arabinofuranosidase characterized by a concentration at 10 000 ARF units/gram. Less concentrated versions of this enzyme exist. This enzyme is characterized in particular in doughs for its dough-drying effect.

In general, most xylanases have an impact on the bread volume. On the other hand, the arabinofuranosidase of the invention, although it is categorized as a xylanase, has no effect on the bread volume.

Dough-drying arabinofuranosidases have recently been used on French breadmaking schemes. In order to limit the gummy phenomena on small-scale schemes which have a greater moisture content than industrial schemes, it is recommended to use this enzyme (Bakezyme ARA 10000 BG) at between 5 and 10 ppm relative to the total flour, in order to correct the glossy or even sticky dough effects.

One of the uses of these novel enzymes is to reduce the stickiness usually generated by conventional endoxylanases on French doughs in a small-scale scheme, which, while they are very effective on the bread volume, are also responsible for the dough being sticky.

The applicant has found that, even when there is an overdose of this arabinofuranosidase in the improver according to the invention, no specific rheological effect on the dough in the crumb-free breadmaking scheme is observed, which is not the case when there is an overdose of this enzyme in the French breadmaking process. In fact, the overdose in the French bread-making process generally leads to toughness or “log-like” phenomena in the breads which are prejudicial to the development of the bread volume.

In fact, in order to maximize the drying effect, it has been necessary to overdose this arabinofuranosidase to the amount of 40 ppm. Beyond this dose, the beneficial effect of the enzyme is less.

The arabinofuranosidase is introduced at a content of between 0.8% and 9%, preferably between 1.2% and 8% by weight of the total weight of the improver.

The applicant has shown that it is also necessary to add at least one drying compound chosen from the group comprising gums, hydrocolloids, fibers and mixtures thereof, in order to accentuate the water retention at kneading or in the steps just after kneading.

By way of example of hydrocolloids, mention may be made of xanthan, sodium alginate, carboxymethylcellulose and guar flour. The preferred hydrocolloid is xanthan.

By way of example of a gum, mention may be made of guar gum.

These hydrocolloids and gums have a good water absorption capacity under cold conditions and are capable of reducing the stickiness of doughs observed with the use of bacterial amylases.

Besides the gums and hydrocolloids, the fibers derived from various plant sources are capable of also having a water retention capacity.

In the case of French or Anglo-Saxon doughs, the effect of the fibers is generally to depress the bread volume. They degrade the dough structure and disadvantage the retention of gas during proving.

On Arab bread, since proving is very short, no problem of this type is observed. The proving and the development in the oven are not modified by the use of gums, hydrocolloids or fibers.

By way of example of fibers that can be used in the improver according to the invention, mention may be made of wheat fibers, soya fibers and carrot fibers. They can be used alone or as a mixture. Carrot fibers are preferably used.

Gums are generally used in breadmaking at from 0.1% to 0.2% relative to the total flour, up to a few percent. Most commonly, the economic cost of gums and hydrocolloids limits their use. In Arab bread, an effect of these gums or of these fibers on the stickiness of doughs is observed in combination with arabinofuranosidase starting from 0.05%. This is the case of xanthan and of carrot fiber. Carrot fiber is preferred, compared with wheat fiber, for its considerable water absorption capacity, but wheat fiber can also be suitable.

The use of the hydrocolloids in breadmaking, by adjusting their water retention properties, can be carried out in two ways: either one works at a constant dough consistency and the addition of hydrocolloid makes it necessary to increase the amount of water used in kneading, or the amount of water during kneading is not modified and, by correlation, the dough is therefore made firmer. This second option is used for flat bread.

The small amount of dough per dough piece (between 100 and 160 grams), the fineness of the dough and the extremely fierce baking do not make it possible to improve the perception of moisture of the bread or its freshness by adding a hydrocolloid, even if this hydrocolloid causes the dough to absorb more water.

The hydrocolloid is therefore only there to finish the “drying” of the dough. The hydrocolloids most suitable for the present invention, without ovalization of the circular dough piece, are xanthan from 0.02% up to 0.2% by weight relative to the flour, and preferably without modification of the moisture content of the dough, sodium alginate from 0.1% and up to 0.5%.

Certain hydrocolloids, despite very good drying of the dough, cause the dough to become tough and generally have an ovalizing effect on the dough piece, which can be disadvantageous. In fact, for good regularity of production, the dough piece should be as circular as possible. However, they can give the dough a nice softness when they are combined with arabinofuranosidase and with bacterial endo-alpha-amylase. This is the case of cellulosic derivatives such as CMCs (carboxymethylcelluloses) and guar flour, in particular from 0.1% relative to the flour.

Fibers such as wheat fibers or carrot fibers also have a water-retaining effect which can also serve to mask or compensate for the stickiness introduced by the bacterial amylase. Conventional wheat fibers work perfectly well. The advantage of carrot fiber is also that it has a considerable water absorption capacity under cold conditions relative to the majority of fibers.

The drying compound (c) represents 90% to 99.1%, preferably 91.2% to 98.5% by weight of the total weight of the improver.

The improver according to the invention can also comprise other additives or adjuvants that are used, such as sunflower oil.

The present invention also relates to the use of the improver as described above in the making and the preparation of crumb-free bread. It is recommended to use the improver of the present invention at a content of between 200 and 3000 ppm relative to the total flour, and preferably at a content of between 400 and 2000 ppm. The improver is added to the flour before kneading.

Another of the subjects of the invention is a crumb-free bread comprising from 200 to 3000 ppm, preferably from 400 to 2000 ppm, of the improver as described above.

The following examples illustrate the invention without limiting the scope thereof.

### EXAMPLES

General Scheme:

All the trials were carried out according to the bread-making scheme given hereinafter:

BREADMAKING SCHEME FOR ARAB BREADS

| | |
|---|---|
| Strong flour | 100% |
| Water | 55% to 62% according to |
| | the quality of the flour |
| Fresh yeast | 0.5% to 1.2% |
| Salt | 0% to 0.6% |
| Sugar | 1% to 3.5% |
| Calcium propionate | 0% to 0.1% |

Kneading: 7 minutes on an industrial kneading machine

Final dough temperature: above 32° C. normally

First fermentation in tank: 45 minutes at 30° C.

Division often automatic

The weights vary at division from 100 to 150 grams

After division, expansion for 10 minutes before flattening of the dough piece

Flattening by several trains of rollers

Second fermentation: 25 minutes at 35° C.

Baking: extremely rapid and hot, 1 minute 10 seconds at 450° C.-500° C.

Control Trials:

Two control trials were carried out. The first does not comprise any improvers (T1). The second comprises 3% of soya fibers relative to the total flour (T2).

Trials According to the Invention:

The improvers according to the invention, the compositions of which are given hereinafter, were tested according to the breadmaking scheme given above. For each trial, the improver was mixed with the flour at a content of 0.1% by weight relative to the weight of the flour.

IMPROVER FORMULAS FOR ARAB BREADS

| | Amount (g) | Percentage (%) |
|---|---|---|
| A1 | | |
| | | 0 |
| Carrot fibers | 95.7 | 95.7 |
| Arabinofuranosidase | 4 | 4 |
| Bacterial endo-alpha-amylase | 0.3 | 0.3 |
| | | 0 |
| Total | 100 | 100 |
| A2 | | |
| | | 0 |
| Xanthan gum | 50 | 50 |
| Sterilized wheat flour | 47.7 | 47.7 |
| Arabinofuranosidase | 2 | 2 |
| Bacterial endo-alpha-amylase | 0.3 | 0.3 |
| | | 0 |
| Total | 100 | 100 |
| A3 | | |
| | | 0 |
| Carrot fibers | 94.7 | 94.7 |
| Arabinofuranosidase | 4 | 4 |
| Bacterial endo-alpha-amylase | 0.3 | 0.3 |
| Sunflower oil | 1 | 1 |
| Total | 100 | 100 |
| A4 | | |
| Nature of the MP | | 0 |
| Sodium alginate | 97.7 | 97.7 |
| Arabinofuranosidase | 2 | 2 |
| Bacterial endo-alpha-amylase | 0.3 | 0.3 |
| | | 0 |
| Total | 100 | 100 |
| A5 | | |
| | | 0 |
| Sterilized wheat flour | 97.7 | 97.7 |
| Arabinofuranosidase | 2 | 2 |
| Bacterial endo-alpha-amylase | 0.3 | 0.3 |
| | | 0 |
| Total | 100 | 100 |
| A6 | | |
| | | 0 |
| Xanthan | 97.7 | 97.7 |
| Arabinofuranosidase | 2 | 2 |
| Bacterial endo-alpha-amylase | 0.3 | 0.3 |
| | | 0 |
| Total | 100 | 100 |
| A7 | | |
| | | 0 |
| Carrot fibers | 97.7 | 97.7 |
| Arabinofuranosidase | 2 | 2 |
| Bacterial endo-alpha-amylase | 0.3 | 0.3 |
| | | 0 |
| Total | 100 | 100 |

The organoleptic qualities of the breads prepared with the various improvers (A1 to A7) were assessed by a panel of 10 testers in comparison with breads prepared with the controls (T1, T2).

The following different qualities were assessed:
freshness to the touch
freshness in the mouth
elasticity of the bread
flexibility of the bread
softness in the mouth

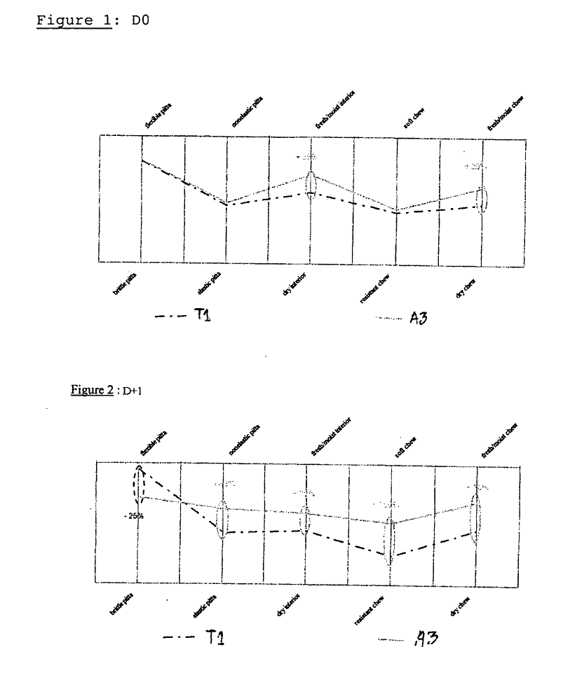

The average results obtained are given in FIGS. 1 to 5.

These properties were assessed immediately after manufacture, i.e. on D0, for the bread prepared with improver A3 and for the bread without improver T1. The results are given in FIG. 1. They were also assessed at D+1 and the results are given in FIG. 2.

It emerges from these FIGS. 1 and 2 that:
the positive effect of the improver A3 is perceptible on the fresh products but is amplified on the 1-day-old breads;
at D0 (fresh breads), a significant improvement in the freshness of the product, to the tough (moisture between the two sheets) +25% and in the mouth (less dry) +30%, is perceived;
at D+1 (FIG. 2): these two effects are reinforced: +32% and +50% and a softer chew is also obtained: +100% and a less elastic bread: ±45%. A negative effect of the improver on the flexibility of the crumb compared with the control is noted: −25%; the bread has a tendency to tear when it is folded. This nevertheless remains within acceptable limits.

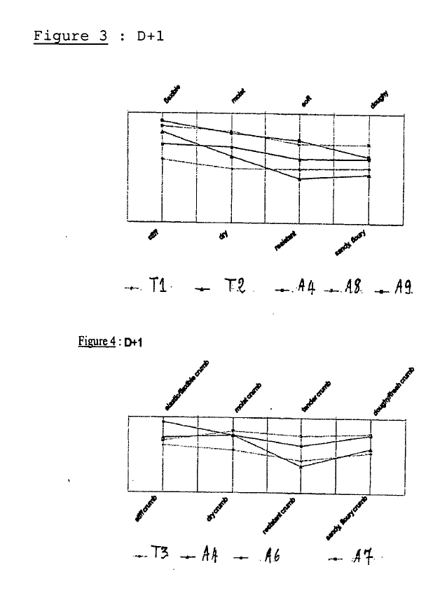

Represented in FIG. 3 are the results obtained with a bread prepared using the improver A4 in comparison with a bread without improver T1 and with improver T2.

Also represented in this figure are the results obtained, firstly, with a bread prepared using an improver comprising 3 ppm of bacterial endo-alpha-amylase, 20 ppm of glucose oxidase and 0.1% of sodium alginate (curve A8 in FIG. 3) and, secondly, with a bread prepared using an improver comprising 6 ppm of bacterial endo-alpha-amylase and 20 ppm of arabinofuranosidase (curve A9 in FIG. 3).

These assessments were made at D+1.

It emerges from this figure that the improver A4 is significantly more advantageous than the control without improver T1 or than the control with soya flour T3, with respect to all the criteria under consideration.

The improvers A_ and A9 give good results in terms of taste and chewing sensation. On the other hand, they posed many problems in terms of rheology and of use at the time of kneading and preparation of the breads. A considerable shrinking of the bread diameter after baking was in particular observed. This makes such improvers unsuitable for industrial applications.

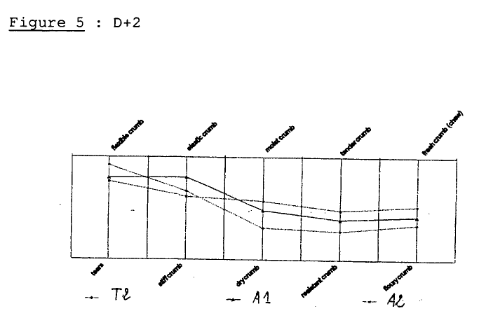

Represented in FIG. 4 are the results obtained with breads prepared using the improvers A4, A6 and A7, in comparison with a bread with improver T2. These assessments were made at D+1.

It emerges from this figure that:
the improver A4 is perceived to be slightly better than the control (crumb moisture to the touch), but not significantly so (the assessment of the product is not quite as good as the previous times);
the improver A6 (formula with xanthan) is very much better perceived. The elasticity/flexibility of the dough in particular, but also the texture when chewing, are improved;
the improver A7 (formula with carrot fiber) is also very well perceived, better than xanthan for the perception in the mouth; on the other hand, it gives a dough which is slightly less elastic and flexible.

Represented in FIG. 5 are the results obtained with breads prepared using the improvers A1 and A2, in comparison with a bread with improver T2. These assessments were made at D+2.

It emerges from this figure that the differences between the products are quite marked. In general, the two improvers of the invention show an advantage for improving the texture of the control:
the improver A1 is more effective than the control with respect to all the criteria, except flexibility (nevertheless, in terms of this criterion, the three breads have very satisfactory results: they tear very little during folding);
the improver A2 is much more effective than the control (and also more than A1) with respect to the criteria of chew and the criterion of moisture to the touch; on the other hand, with respect to flexibility and elasticity, this formula is equivalent to or even less effective than the control.

1.-14. (canceled)

15. A bread improver comprising:
a) from 0.1% to 1% by weight of the total weight of the improver of at least one antistaling enzyme chosen from maltogenic exoamylases and bacterial endo-alpha-amylases;
b) from 0.8% to 9% by weight of the total weight of the improver of at least one arabinofuranosidase; and
c) from 90% to 99.1% by weight of the total weight of the improver of at least one drying compound chosen from the group comprising gums, hydrocolloids, fibers and mixtures thereof.

16. The improver according to claim 15, comprising:
a) from 0.3% to 0.8% by weight of the total weight of the improver of at least one antistalling enzyme chosen from maltogenic exoamylases and bacterial endo-alpha-amylases;
b) from 1.2% to 8% by weight of the total weight of the improver of at least one arabinofuranosidase; and
c) from 91.2% to 98.5% by weight of the total weight of the improver of at least one drying compound chosen from the group comprising gums, hydrocolloids, fibers and mixtures thereof.

17. The improver according to claim 15, wherein the antistalling enzyme is chosen from bacterial endo-alpha-amylase enzymes such as Ban 800 MG.

18. The improver according to claim 15, wherein said arabinofuranosidase is Bakezyme ARA 1000 BG.

19. The improver according to claim 15, wherein said gum is guar gum.

20. The improver according to claim 15, wherein said hydrocolloid is chosen from the group comprising xanthan, sodium alginate, guar flour, carboxymethylcellulose and mixtures thereof.

21. The improver according to claim 20, wherein the hydrocolloid is xanthan.

22. The improver according to claim 15, wherein said fiber is chosen from the group comprising wheat fibers, soya fibers, carrot fibers and mixtures thereof.

23. The improver according to claim 22, wherein the fiber is carrot fiber.

24. The improver according to claim 15, which also comprises other additives and adjuvants for formulation, such as sunflower oil.

25. A method for making crumb-free bread, which comprises the use of the improver according to claim 15, at a content of between 200 and 3000 ppm relative to the flour.

26. The method according to claim 25, wherein said content is between 400 and 2000 ppm relative to the flour.

27. A crumb-free bread comprising the improver according to claim 15.

28. A crumb-free bread prepared according to the method of claim 25.
